(19) United States
(12) Patent Application Publication
(10) Pub. No.: US 2005/0091015 A1
(43) Pub. Date: Apr. 28, 2005

(54) Method and apparatus for modeling a uniform transmission line

(76) Inventor: Vahe Adamian, Westlake Village, CA (US)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/695,850

(22) Filed: Oct. 28, 2003

(51) Int. Cl. G06F 17/10

(52) U.S. Cl. 703/2

(57) ABSTRACT

A method and apparatus for modeling a uniform transmission line obtains measured s-parameters of an connectivity system in combination with the uniform transmission line and mathematically isolates a representative portion of the uniform transmission line from the connectivity system by identifying an electrical position of the representative portion as distinct from the connectivity system. The measured s-parameters are adjusted to represent s-parameters of only the representative portion. Telegrapher's Equation transmission parameters are then extracted from the adjusted measured s-parameters.

### BACKGROUND

As clock speeds in digital communications systems evolve into the Gigahertz region and above, analog properties of transmission lines that carry the digital information become important considerations. Digital designers typically maintain a library of uniform transmission line models to aid in a digital design and simulation process. Accurate uniform transmission line models improve the reliability of the simulated digital system and can help identify critical paths in the design. By concentrating on robust design of the critical paths and accurately simulating the digital design, a digital designer is able to reduce design time and efficiently produce quality products.

In low frequency applications, it is possible to simply measure a uniform transmission line to obtain its transmission parameters using low frequency stimulus. As frequencies increase, however, it is most reliable, and therefore, desirable to model the uniform transmission line behavior based upon measurements at frequencies that the transmission lines are expected to carry. In order to measure uniform transmission lines at high frequencies, a “connectivity system” such as a connector or a probing system in electrical communication with the uniform transmission line is used. The connectivity system is disposed between the uniform transmission line to be measured and the measurement hardware, typically a high frequency vector network analyzer (herein “VNA”). Even after calibration of the VNA to a measurement reference plane and error correction for the systematic error coefficients, the VNA measurement of the uniform transmission line includes a measurement contribution of the connectivity system. Because the connectivity system is not a part of the digital design, transmission parameters that are based upon measurements of the uniform transmission line include measurement contribution from the connectivity system. The measurement contribution from the connectivity system distorts the model making the resulting transmission line model and the simulations that use the model less reliable. There is a need, therefore, to obtain a model of a transmission line as isolated from the connectivity system.

### BRIEF DESCRIPTION OF THE FIGURES

FIG. 1 is an illustration of a vector network analyzer (herein “VNA”) measurement system.

FIG. 2 is an illustration of an embodiment of a fixture for measurement of two uniform transmission line configurations. Shown in the illustration is a probed uniform transmission line configuration and a connectorized uniform transmission line configuration.

FIG. 3 is an illustration of the VNA measurement system connected to the connectorized uniform transmission line configuration.

FIG. 4 is an illustration of a VNA connected to the probed uniform transmission line configuration.

FIG. 5 is a detail view of the probe as connected to a landing pad and signal landing for the probed uniform transmission line configuration.

FIGS. 6 and 7 are graphs showing magnitude and phase, respectively, as a function of frequency of measured reflection and transmission s-parameters of the probed uniform transmission line configuration.

FIG. 8 is a graph showing an impulse response transformation of the measured S₁₁ reflection parameter of FIGS. 6 and 7. The impulse response is presented as a linear reflection coefficient as a function of time in nanoseconds.

FIG. 9 is a graph of a gated reflection impulse response based upon the data shown in FIG. 8.

FIG. 10 is a graph of magnitude and phase of the gated reflection impulse response of FIG. 9 converted back to the frequency domain with the phase information also shown overlaid with a phase adjusted for an electrical length equal to a start gate.

FIG. 11 is a graph showing an impulse response transformation of the measured S₂₁ transmission parameter. The impulse response is presented as a linear transmission coefficient as a function of time in nanoseconds.

FIG. 12 is a graph showing magnitude and phase components of the measured transmission s-parameter overlaid with a scaled magnitude component of the transmission s-parameter and a phase adjusted component of the transmission s-parameter.

FIG. 13 shows Telegrapher's Equation transmission parameters, as a function of frequency extracted from measured and adjusted reflection and transmission s-parameters from the probed uniform transmission line configuration.

FIG. 14 is a graph of the S₂₁ transmission parameter recalculated from the Telegrapher's Equation Transmission parameters for the probed uniform transmission line configuration.

FIG. 15 is a flowchart of an embodiment of a process according to the present teachings.

FIG. 16 is a graph showing an impulse response transformation of the measured S₁₁ reflection parameter for the connectorized uniform transmission line configuration. The impulse response is presented as a linear reflection coefficient as a function of time in nanoseconds.

FIG. 17 is a graph of a gated reflection impulse response based upon the data shown in FIG. 16.

FIG. 18 shows Telegrapher's Equation transmission parameters extracted from measured and adjusted reflection and transmission s-parameters from the connectorized uniform transmission line configuration.

FIG. 19 is a graph of the S₂₁ parameter recalculated from the Telegrapher's Equation parameters extracted from measurements made of the connectorized uniform transmission line configuration. The result illustrates consistency with the recalculated S₂₁ transmission parameter based upon the probed uniform transmission line configuration as shown in FIG. 14.

### DETAILED DESCRIPTION

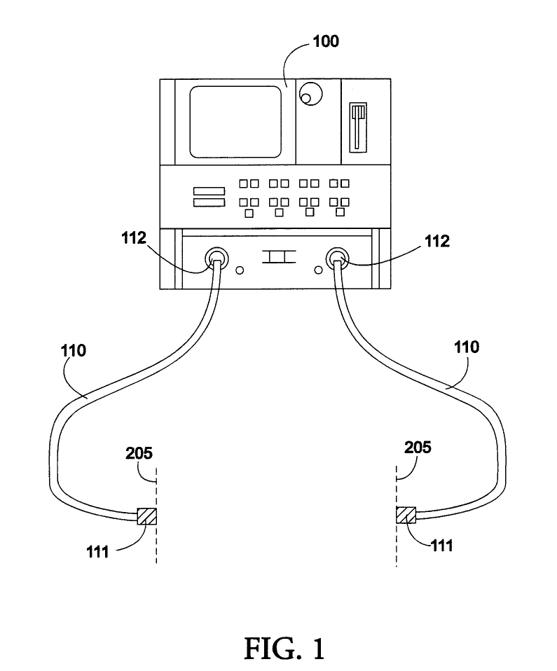

With specific reference to FIG. 1 of the drawings, there is shown a vector network analyzer measurement system (herein “VNA measurement system”) 100 conventionally used to make high frequency magnitude and phase measurements of a device under test. The VNA measurement system 100 has coaxial VNA measurement cables 110 connected to VNA ports 112. Coaxial VNA measurement ports 111 are disposed at a measurement end of the VNA measurement cables 110 and represent the measurement ports of VNA measurement system 100. The VNA measurement system 100 is calibrated by performing a conventional calibration to extract systematic error coefficients of the VNA measurement system 100. This calibration may be performed using any number of the conventional methods using calibration standards. This calibration step provides for a calibration of the VNA measurement system 100 to a coaxial measurement reference plane 205.

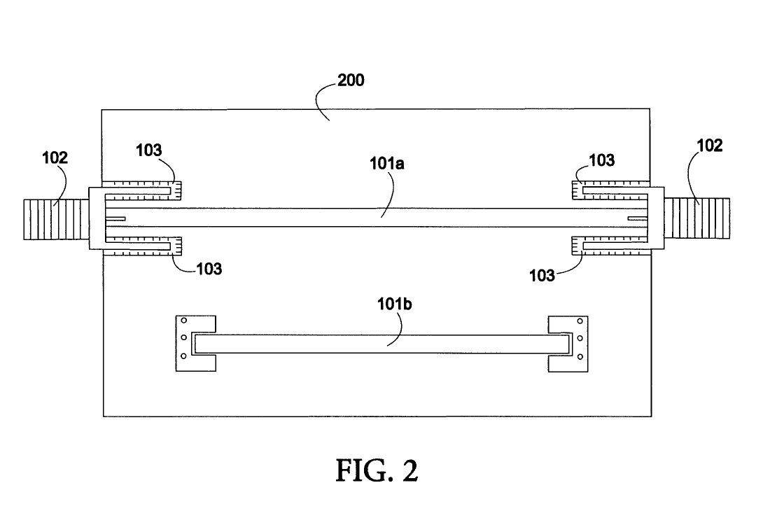

With specific reference to FIG. 2 of the drawings, there is shown a fixture 200 for measurement of two configurations of uniform transmission lines including a connectorized uniform transmission line configuration 101a and a probed uniform transmission line configuration 101b. The fixture 200 is a printed circuit board substrate, such as FR4 or other known suitable material, with a ground plane (not shown) on one surface and having the printed uniform transmission lines 101a, 101b on an opposite surface (as shown). The ground plane and printed uniform transmission lines 101a, 101b may be made of copper or other suitable conductive material. The uniform transmission lines 101a, 101b are made of identical material and have the same transmission line dimensions and, therefore, are presumed to have the same electrical transmission characteristics per unit length. From the illustration of FIG. 2, however, it is appreciated that the uniform transmission line configurations 101a, 101b have differing absolute lengths.

A first configuration of the uniform transmission line 101a is connectorized with two instrument grade coaxial connectors 102. A signal line connection is made to the uniform transmission line 101a by soldering a center conductor of each coaxial connector 102 to distal ends of the printed uniform transmission line 101a. A ground connection is made between the coaxial connector ground and conductive strips 103 that flank the uniform transmission line 101a, which are further electrically connected to a ground plane (not shown) of the fixture 200.

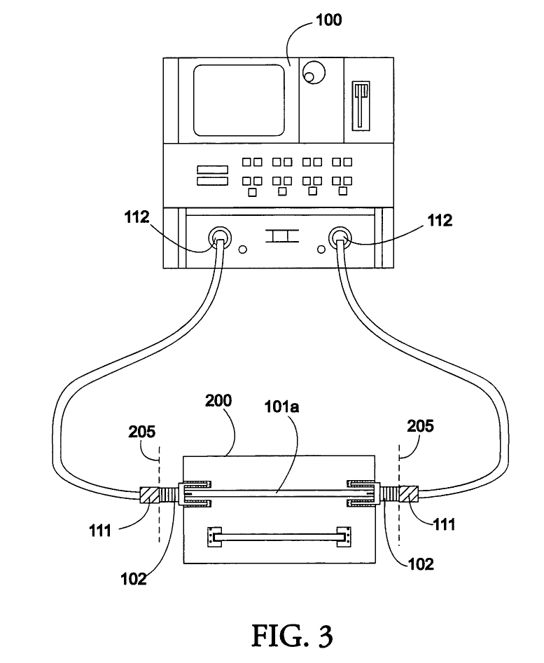

With specific reference to FIG. 3 of the drawings, the connectorized transmission line 101a is shown as connected to the VNA measurement system 100 through VNA measurement ports 111. The VNA measurement ports 111 are connected to respective one of the coaxial connectors 102 of the connectorized uniform transmission line 101a. The portion of the connectorized transmission line 101a disposed between the VNA measurement reference plane 205 and the uniform transmission line 101a is the connectivity system in the connectorized configuration. Because the connectivity system is on a measurement side of the measurement reference plane 205, the connectivity system contributes to results obtained from a measurement of the connectorized uniform transmission line 101a.

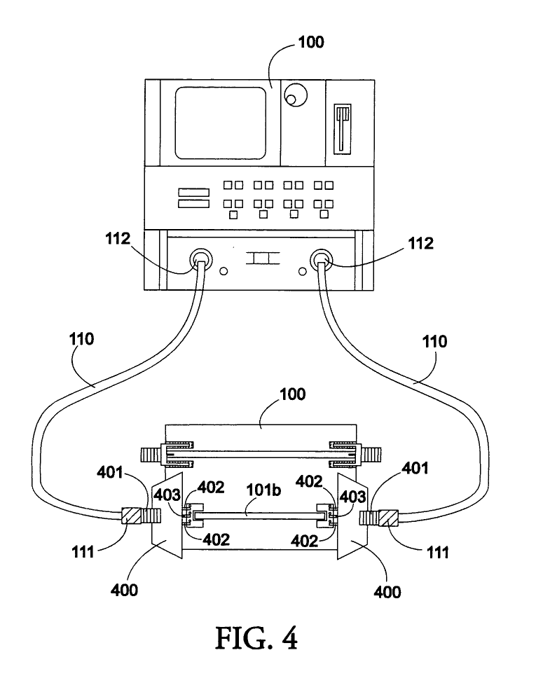

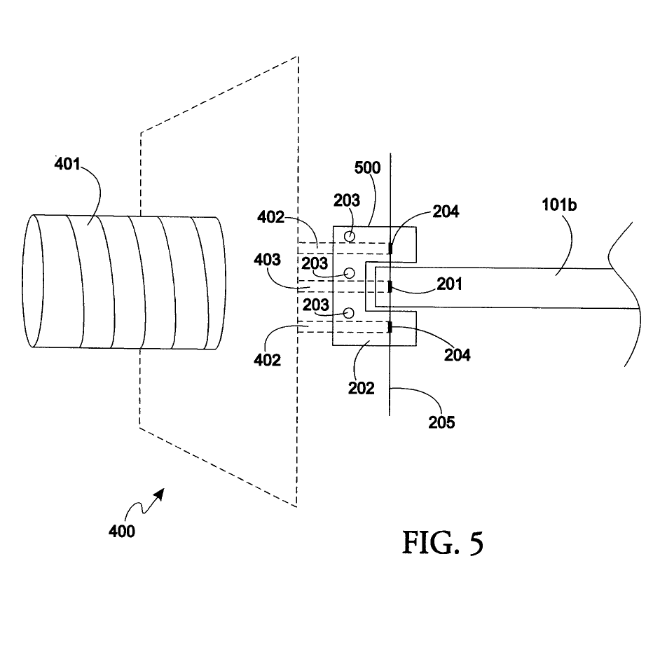

With specific reference to FIGS. 2, 4, and 5 various aspects of a second configuration of the uniform transmission line 101b that populates the fixture 200 is shown. The second configuration is a “probed” configuration and is configured for electrical connection with a co-planar ground-signal-ground (herein “G-S-G”) probe 400. FIG. 2 of the drawings illustrates the probed configuration of the uniform transmission line 101b disposed on the same fixture 200 as the connectorized configuration of the uniform transmission line 101a. For purposes of proving the reliability of a method according to the present teachings, both configurations of the uniform transmission lines 101a, 101b are printed at the same time using the same manufacturing process and material and having the same dimensions. Accordingly, the transmission parameters per unit length of the two configurations should be substantially similar to each other. FIGS. 4 and 5 of the drawings illustrate the VNA measurement system 100 connected to two co-planar G-S-G probes 400 that access the probed configuration of the uniform transmission line 101b. The co-planar G-S-G probes 400 comprise three probe tips 402 and 403 that make the ground-signal-ground connection. A signal probe tip 403 is electrically connected to a signal line (not shown) and grounded shield (not shown), respectively, of a probe coaxial connector 401. The probe coaxial connector 401 is mateable with the coaxial VNA measurement ports 111. With specific reference to FIG. 5 of the drawings, there is shown a detail view of one co-planar ground-signal-ground (“G-S-G”) probe 400 as connected to the probed uniform transmission line 101b. The connectivity system of the probed transmission line 101b comprises two U-shaped conductive probe landings 500 disposed at opposite ends of the probed uniform transmission line 101b. Each probe landing 500, which may be made of the same material as the transmission lines 101, is a single conductive area disposed around an end of the transmission line 101b. One or more vias 203 electrically connect the probe landing 500 with the ground plane (not shown) that is on a side of the fixture 200 opposite the side with the uniform transmission lines 101a, 101b. Each co-planar probe 400 comprises a signal probe tip 403 in the center for contact with a signal line landing 201. The signal probe tip 403 is flanked on either side with a ground probe tip 402 for contact with respective ground plane landing pads 204. Accordingly, each co-planar G-S-G probe 400 makes a ground-signal-ground connection at either end of the probed transmission line 101b. During a calibration procedure using on-wafer standards, it is possible to establish a measurement reference plane 205 at the probe tips 201, 204. Based upon a position of the measurement plane 205, the connectivity system that contributes to a measurement of the probed transmission line 101b comprises just the electrical connection between the probe tips 201, 204 and the signal and landing pads of the uniform transmission line 101b. This connectivity system is much smaller than the connectivity system that is part of the measurement of the connectorized transmission line 101a, but remains as part of the measurement of the uniform transmission line. Accordingly, the absolute measurements made of the probed uniform transmission line configuration 101b and the longer connectorized uniform transmission line configuration 101a are different even though the transmission parameters per unit length are expected to be substantially similar.

The teachings herein provide a method for removing effects the connectivity system has on the measurement of the probed and connectorized transmission lines 101a, 101b in order to more reliably model the uniform transmission line 101 as separate from the connectivity system that is necessarily part of the measurement.

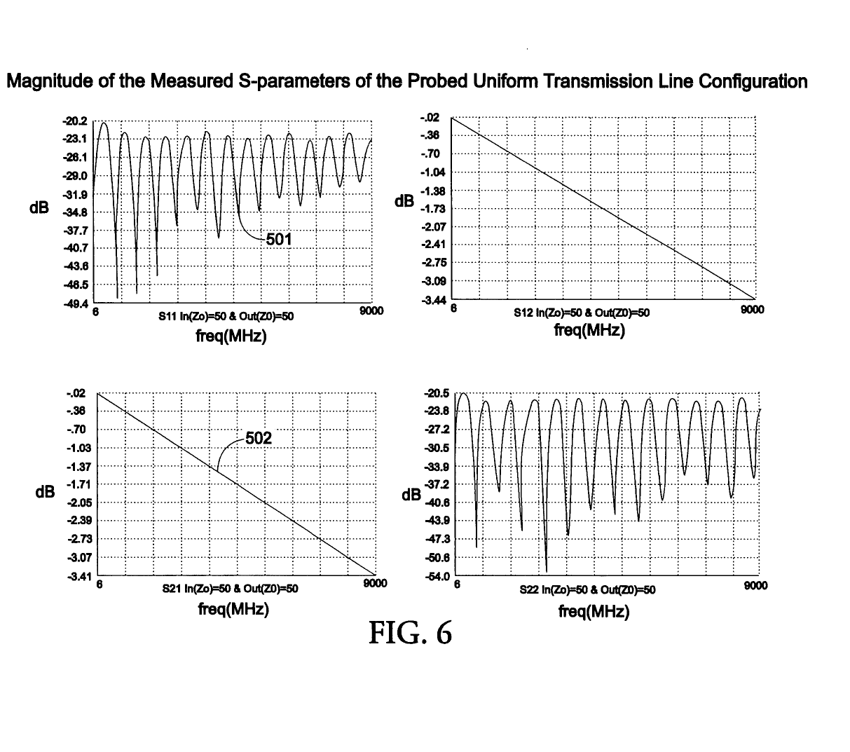

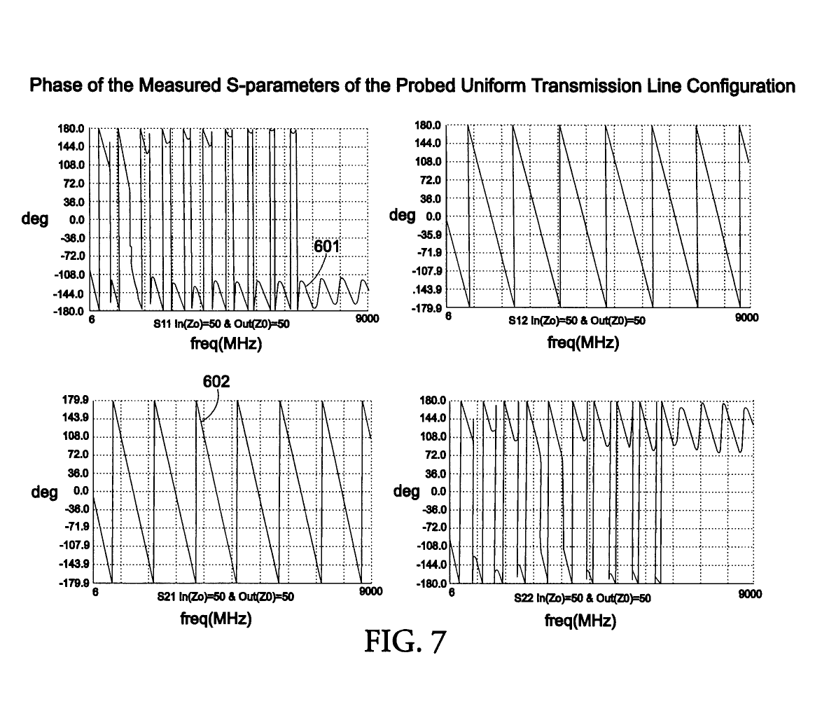

In an embodiment of a method according to the present teachings, a VNA measurement system 100 that measures a probed or connectorized uniform transmission line 101a or 101b is calibrated according to conventional methods. With specific reference to FIGS. 6 and 7 of the drawings, there is shown a graph of magnitude (FIG. 6) and phase (FIG. 7) reflection and transmission s-parameters for a probed transmission line 101b with respect to the measurement plane 205. A magnitude component of the S₁₁ reflection s-parameter is shown as 501 and a magnitude component of the S₂₁ transmission s-parameter is shown as 502. A phase component of the S₁₁ reflection s-parameter is shown as 601 and a phase component of the S₂₁ transmission s-parameter is shown as 602. For ease of reference, the calibrated, measured and corrected reflection and transmission s-parameters of the uniform transmission line configurations in combination with the connectivity system that are shown are herein referred to as the measured reflection and transmission s-parameters. Extraction of Telegrapher's Equation transmission parameters from the measured reflection and transmission s-parameters of the uniform transmission line 101b without removing the effects of the connectivity system creates undesirable errors in a model upon which the affected measurement is based.

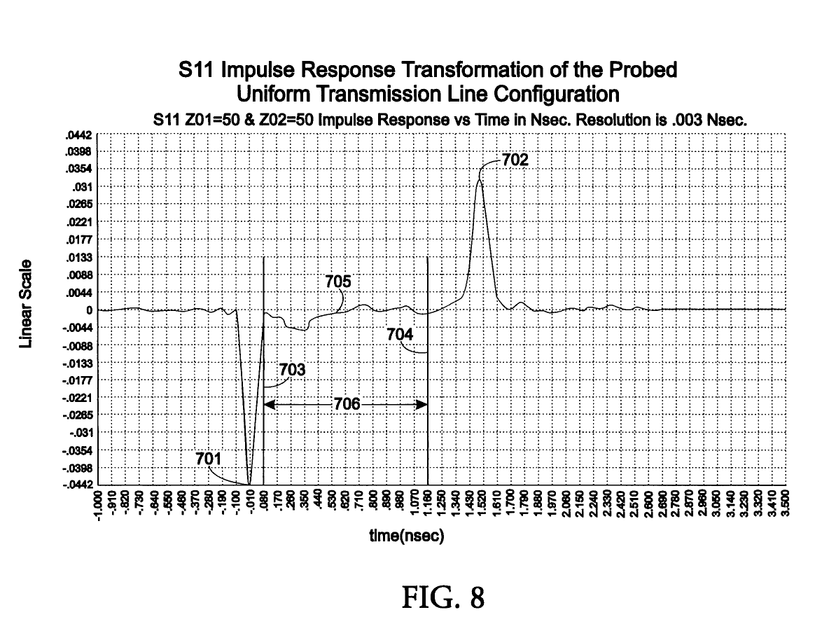

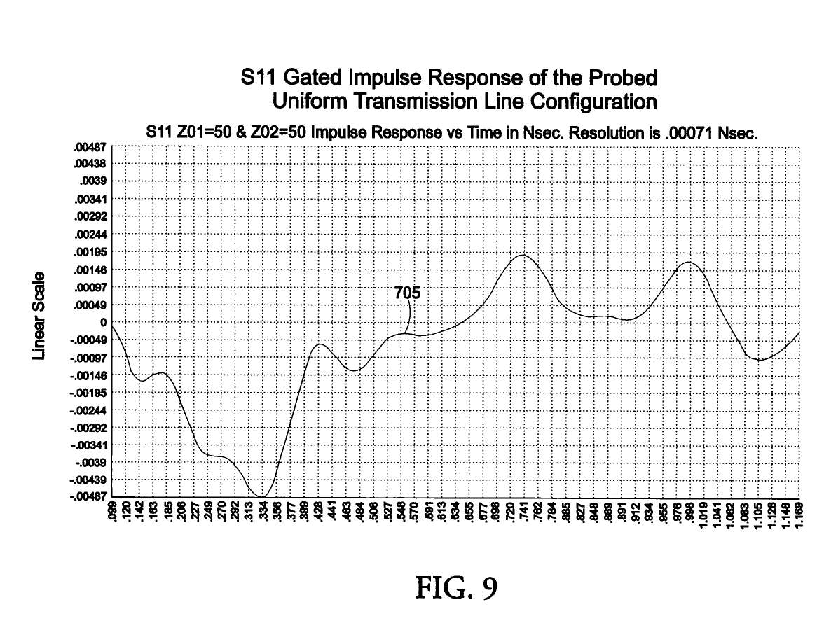

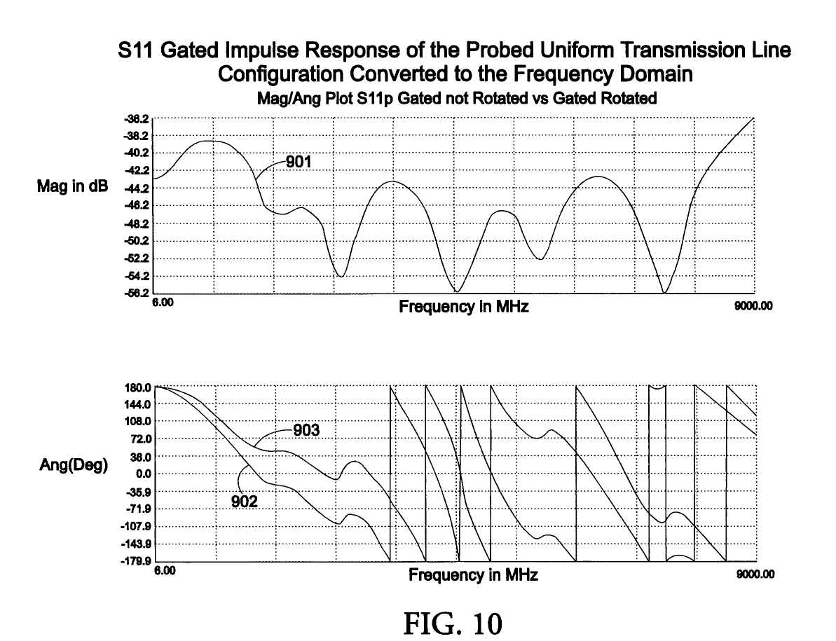

In a next step of an embodiment of a method according to the present teachings, the measured reflection s-parameter 501 of the probed transmission line 101b is transformed to the time domain using an impulse response singularity function. With specific reference to FIG. 8 of the drawings, there is shown the impulse response of the measured S₁₁ reflection parameter for the probed uniform transmission line configuration 101b. The impulse response shown in FIG. 8 indicates two separate and distinct measurement delineations identified as a minimum value 701 and a maximum value 702 at respective electrical times. The first delineation 701 shows the minimum value over a total range of a measured electrical delay. The point that reflects the minimum value in the example illustrated indicates a position of an input portion of the connectivity system. The second delineation 702 shows the maximum value over the total range of the measured electrical delay. The point that reflects the maximum value indicates a position of an output portion of the connectivity system. The method then identifies a start gate 703, which is a data point along the measured range that is disposed after the first delineation 701 and has a magnitude of approximately zero. It is not necessarily a first zero crossing after the first delineation 701, but it is suggested to obtain a start gate 703 that is after and relatively close to the first delineation 701 in order to get a sufficient number of data points to assure reliable results. The method then identifies a stop gate 704. The stop gate 704 is a data point that is disposed after the start gate 703 and before the second delineation 702 and also has a magnitude of approximately zero. The reflection impulse response data is then gated by setting all data points before the start gate 703 to zero and by setting all data points after the stop gate 704 to zero. The gated reflection impulse response 705 establishes a representative portion of the probed uniform transmission line configuration 101b isolated from the data attributable to the connectivity system. The electrical length between the start gate 703 and the stop gate 704 is a gated electrical length 706. With specific reference to FIG. 9 of the drawings, there is a shown a graph of the gated reflection impulse response 705 for the representative portion of the transmission line 101b with the amplitude and time ranges adjusted to show additional detail. The gated reflection impulse response 705 is then converted back into the frequency domain to obtain a gated S₁₁ reflection parameter magnitude 901 and phase 902 components, which is shown in FIG. 10 of the drawings.

As a result of the gating step, the reference plane of the gated S₁₁ reflection parameter is shifted by an amount equal to the electrical length of the start gate 703. If the measured and gated S-parameter is represented as:
S=|ρ|e^{-jθ}^{_{gated}}
where ρ is the linear representation of the reflection S-parameter shown as reference numeral 901 and the phase component of the measured reflection s-parameter 903 is adjusted according to:
θadjusted=θ_{gated}_{—}ₘₑₐₛ+δθ (2)
where:
   δθ=−0.0120083fl (3)
   Where l is the electrical length of the start gate in cm and f is frequency in MHz and Insec is equal to 29.99793 cm in air. The resulting adjusted phase component of the reflection s-parameter is shown as trace 903 and is overlaid with the phase component of the gated reflection parameter 902. At this point, the magnitude and phase components of the measured S₁₁ reflection parameter represent the probed uniform transmission line configuration 101b as isolated from the connectivity system.

The method described is equally applicable to the connectorized transmission line configuration 101a. The trace shown in FIG. 8 of the drawings is for the probed transmission line configuration 101b, but the connectorized transmission line configuration 101a shows a similar profile with minimum and maximum delineations that define the outer limits of a gated response. Accordingly, traces for the connectorized transmission line configuration 101a are not reproduced herein.

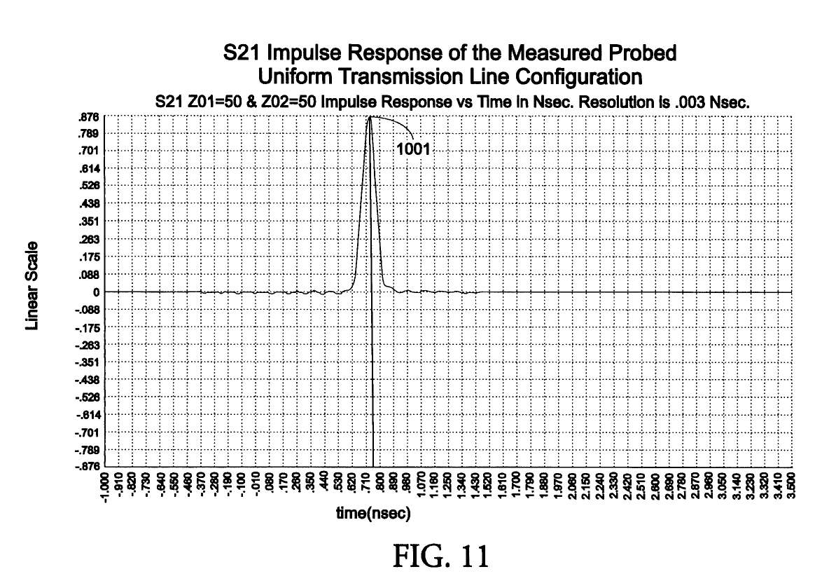

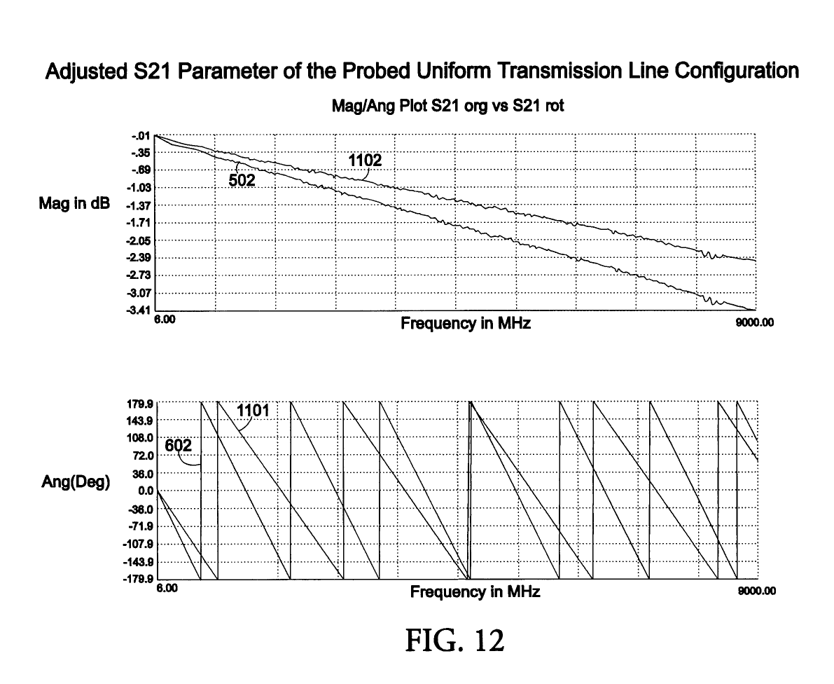

With specific reference to FIG. 1I of the drawings, there is shown a transmission impulse response of the measured S₂₁ transmission parameter for the probed uniform transmission line configuration 101b. A peak value 1001 indicates an electrical length of the measured device. Accordingly, the electrical delay at the peak value 1001 indicates a total electrical length of the measured combination of the connectivity system and the probed uniform transmission line configuration 101b. In order to appropriately adjust the measurement reference plane shift resulting from the gating process, a shift totaling the electrical length of the connectivity system in combination with the probed transmission line configuration 101b less the total electrical length of the representative portion of the transmission line 101 gives the electrical length of the portion of the S₂₁ transmission measurement that is attributable to the connectivity system. Accordingly, equation (1) is used to adjust the phase component of the S₂₁ transmission parameter 602 by an amount equal to the electrical length of the entire system less the representative portion. The appropriate electrical length used to shift the phase component of the S₂₁ transmission parameter is:

$${l}_{s 21 adjusted} = {l}_{total} - ( \frac{{l}_{stopgate} - {l}_{stargate}}{2} ) \qquad ( 4 )$$

where l₂ adjusted is the electrical length in centimeters (cm) that is used to adjust the phase component of the measured S₂₁ transmission parameter, lₜₒₜₐₗ is the electrical length in cm at the peak value shown in FIG. 11 of the drawings indicating a total electrical length of the connectivity system in combination with the uniform transmission line 101, l_{stopgate} is the electrical length of the stop gate 703 in cm, and l_{startgate} is the electrical length of the start gate 704 in cm. The l_{21adjust} term is used to calculate δθ according to equation (3) for purposes of adjusting the phase component of the measured S₂₁ transmission parameter and then θ_{s21adjusted} is calculated according to equation (2). The difference between the start gate 703 and stop gate 704 is divided by two because the start and stop gates 703, 704 are determined using a reflection measurement while the total electrical length is determined using a transmission measurement. As one of ordinary skill in the art appreciates, reflection measurements comprise an aggregate forward and reverse path, while transmission measurements comprise just a forward or reverse path. FIG. 12 of the drawings shows the adjusted phase component 1101 of the measured S₂₁ transmission parameter overlaid with the phase component of the measured S₂₁ transmission parameter 602.

FIG. 12 of the drawings also shows a graph of the magnitude component 502 of the measured S₂₁ transmission parameter as a function of frequency. To isolate the connectivity system from the combination of the connectivity system and the uniform transmission line 101, the magnitude component 502 of the S₂₁ transmission parameter is scaled based upon a percentage of the electrical length of the representative portion of the transmission line 101 as compared to the electrical length of the connectivity system in combination with the transmission line 101. Specifically:

$$\begin{matrix}{MdB}_{s 21 adjusted} = \frac{( \frac{{l}_{stopgate} - {l}_{stargate}}{2} )}{{l}_{total}} 20 log ( {S}_{21 \_magnitude \_meas} ( f ) ) \\ and & ( 5 ) \\ {Mag}_{s 21 adjusted} = {10}^{\frac{{MdB}_{s 21 adjusted}}{20}} & ( 6 )\end{matrix}$$

where Mag_{s21adjusted} is the adjusted magnitude component of the S₂₁ transmission parameter as a function of frequency. FIG. 12 of the drawings shows the adjusted magnitude component 1102 of the measured S₂₁ transmission parameter overlaid with the magnitude component of the measured S₂₁ transmission parameter 502.

The process thus described results in S₁₁ reflection and S₂₁ transmission parameters of the representative portion of the uniform transmission line 101 mathematically isolated from the connectivity system. The resulting S₁₁ and S₂₁ parameters of the probed uniform transmission line configuration 101b as isolated from the connectivity system are used for purposes of extracting Telegrapher's Equation transmission parameters. There are a number of methods of extraction that use the s-parameters as input. An example of a suitable process for purposes of the present teachings is described in “S-Parameter-Based IC Interconnect Transmission Line Characterization” by William R. Eisenstadt et al. published in IEEE Transactions on Components, Hybrids, and Manufacturing Technology, Vol. 15, No. 4, August 1992, the teachings of which are hereby incorporated by reference.

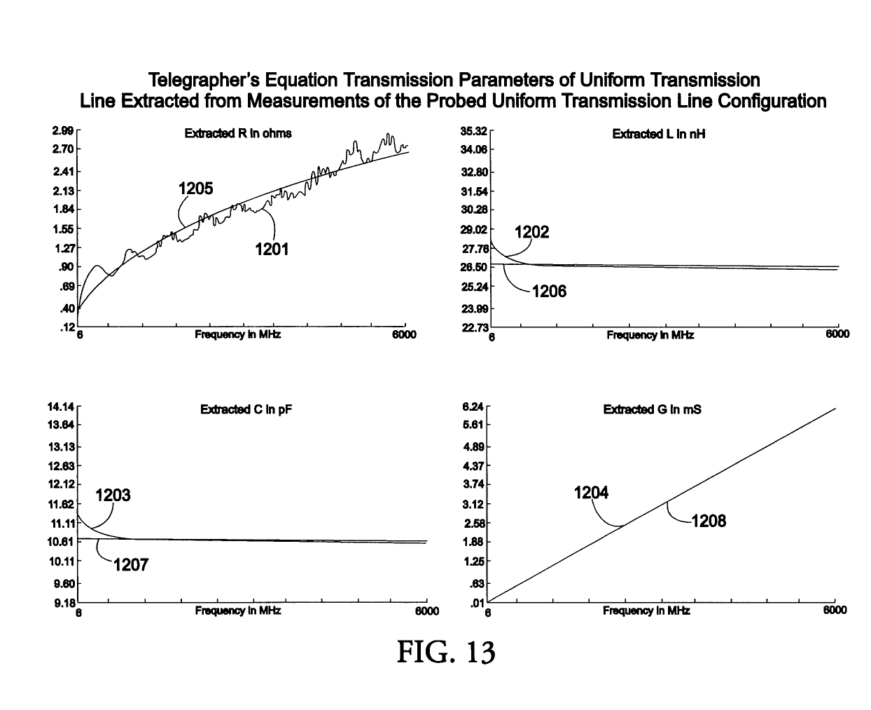

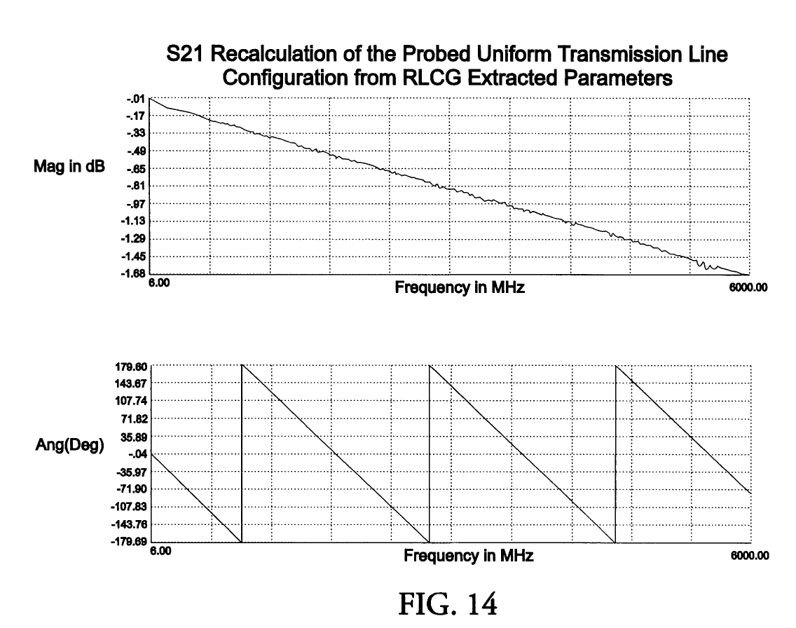

With specific reference to FIG. 13 of the drawings, there is shown the Telegrapher's Equation Transmission parameters which include Resistance (R) 1201, Inductance (L) 1202, Capacitance (C) 1203 and Conductance (G) 1204 values calculated as described herein and normalized to a unit length as a function of frequency. The values as calculated from the measured and gated data are fitted using a least sum squares algorithm and the result of the fit shown as traces 1205, 1206, 1207 and 1208 are overlaid on the calculated values shown as reference numerals 1201, 1202, 1203, and 1204 respectively. It can be seen that the fitted curves correlate with theoretical values expected of a uniform transmission line as described by University of California at Berkeley SPICE circuit simulation. With specific reference to FIG. 14 of the drawings, there is shown a graph of the S₂₁ transmission parameter as recalculated from the Telegrapher's Equation Transmission parameters extracted from measurements made of the probed uniform transmission line configuration 101b.

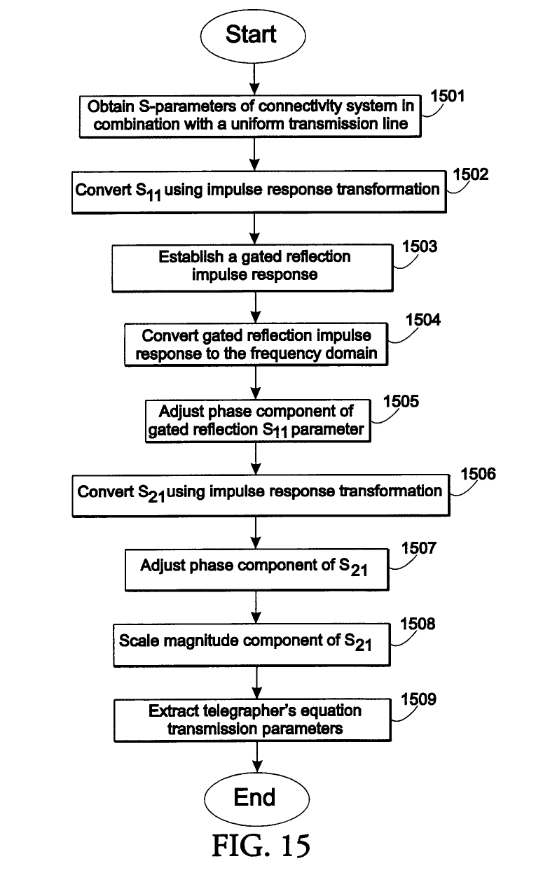

With specific reference to FIG. 15 of the drawings, there is shown a flow graph of process steps in an embodiment according to the present teachings in which s-parameter measurements are made 1501 of the connectivity system in electrical combination with a uniform transmission line 101, either the probed or connectorized configurations, using the VNA measurement system 100. After calibration of the VNA measurement system 100, a position of the measurement reference plane 205 dictates that any measurement of the transmission line 101 includes the measurement contribution of the connectivity system. The VNA measurement system 100 may be connected over a communications bus to a computer (not shown) for direct transmission of the measurement data from the VNA measurement system 100 to the computer or, alternatively, the VNA measurement system 100 may store the data on removable media, which is read by the computer. The computer typically performs all remaining steps in the process according to the present teachings. In another embodiment, if the VNA measurement system 100 contains a processor with sufficient computational power, all steps of a method according to the present teachings may be performed in the VNA measurement system 100.

The measured S₁₁ reflection parameter is then converted 1502 to its time domain impulse response equivalent using a Fast Fourier Transformation (herein “FFT”) process. An example of the reflection impulse response measurement is shown in FIG. 8. First and second delineations 701, 702, respectively, are then identified. In the example of FIG. 8, the minimum value is the first delineation 701 and represents the reflection impulse response of the input portion of the connectivity system. The maximum value is the second delineation 702 and represents the reflection impulse response of the output portion of the connectivity system. A data point later in time having a zero magnitude is established as the start gate 703. The start gate 703 is a data point that delineates the input portion of the connectivity system from the measured uniform transmission line 101. A data point having a zero magnitude and being later in time than the start gate 703, but prior in time to the second delineation 702 is established as the stop gate 704. The electrical length 706 between the start gate 703 and the stop gate 704 is the electrical length of a representative portion of the uniform transmission line isolated from the input and output portions of the connectivity system. All data points prior to the start gate 703 and later to the stop gate 704 are set to a zero value to establish 1503 a gated reflection impulse response 705 as shown in FIG. 9 of the drawings. The gated reflection impulse response 705 represents the impulse response attributable to just a representative portion of the uniform transmission line 101. The start and stop gates 703, 704 coarsely delineate the connectivity system from the transmission line 101. Because the transmission line 101 is a uniform transmission line, there is sufficient information to accurately characterize it in terms of Telegrapher's Equation transmission parameters per unit length.

The gated reflection impulse response is then converted 1504 into the frequency domain using a conventional FFT process to generate a gated S₁₁ reflection parameter. The magnitude component of the gated S₁₁ reflection parameter reflects the s-parameter of just the representative portion of the transmission line 101. The phase component, however, is shifted as a result of the gating process. Accordingly, the phase component of the S₁₁ reflection parameter is adjusted 1505 so that the measurement reference plane 205 coincides with the start gate using equations (1) through (3) herein. The adjusted S₁₁ phase component is shown as 903 in FIG. 10 of the drawings.

The measured S₂₁ transmission parameter is then converted 1506 to the impulse response time domain equivalent. See FIG. 11 of the drawings. A peak value 1001 of the transmission impulse response indicates a total electrical length of the connectivity system in combination with the transmission line 101. In order to adjust the measured transmission s-parameters to reflect just the representative portion of the uniform transmission line 101, the phase component of the measured transmission s-parameter is adjusted 1507 by the electrical length of both the input and output portions of the connectivity system. The adjustment is performed by calculating the adjusted electrical length as in equation (4) and calculating the adjusted phase as a function of frequency using the adjusted electrical length in equation (2).

The magnitude component of the measured S₂₁ transmission parameter is also adjusted. The magnitude component is scaled so that the magnitude represents only the loss attributable to the representative portion of the transmission line 101. Specifically, a ratio of the electrical length of just the representative portion relative to the total electrical length of the connectivity system in combination with the uniform transmission line 101 is multiplied by the scalar value using equation (5). The resulting corrected scalar value is then converted to units of dB as in equation (6). An example of adjusted values of S₂₁ is shown in FIG. 12 of the drawings.

From the resulting S₂₁ and S₁₁ parameters that are adjusted to reflect just the representative portion of the uniform transmission line 101, the Telegrapher's Equation transmission parameters may be extracted 1509 normalized to a unit length of uniform transmission line. From the extracted parameters, the complex characteristic impedance and complex propagation constant may also be determined. Digital designers use the extracted parameters to accurately represent lengths of transmission line in their printed circuit board designs.

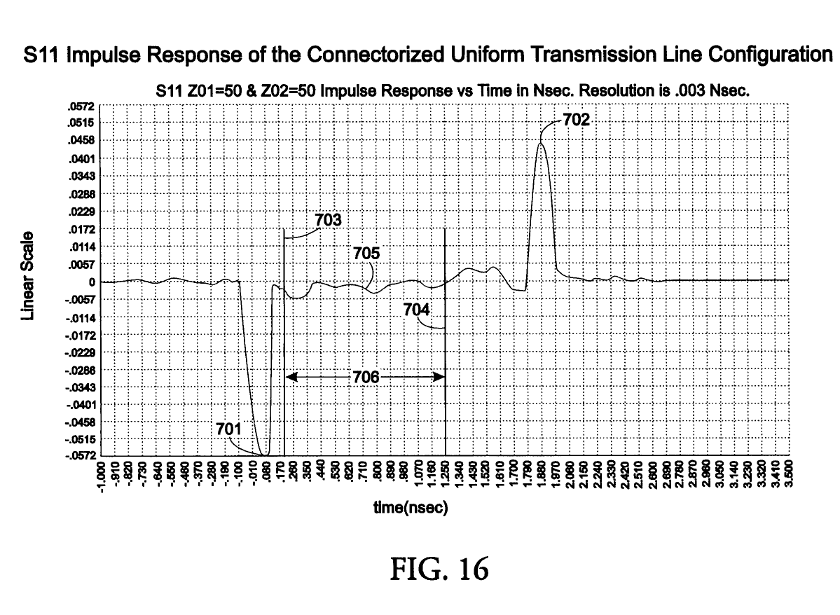

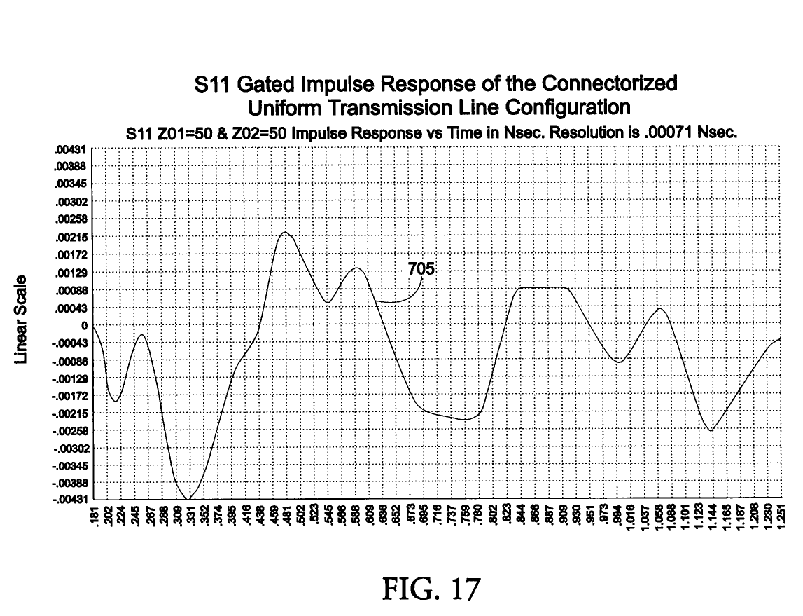

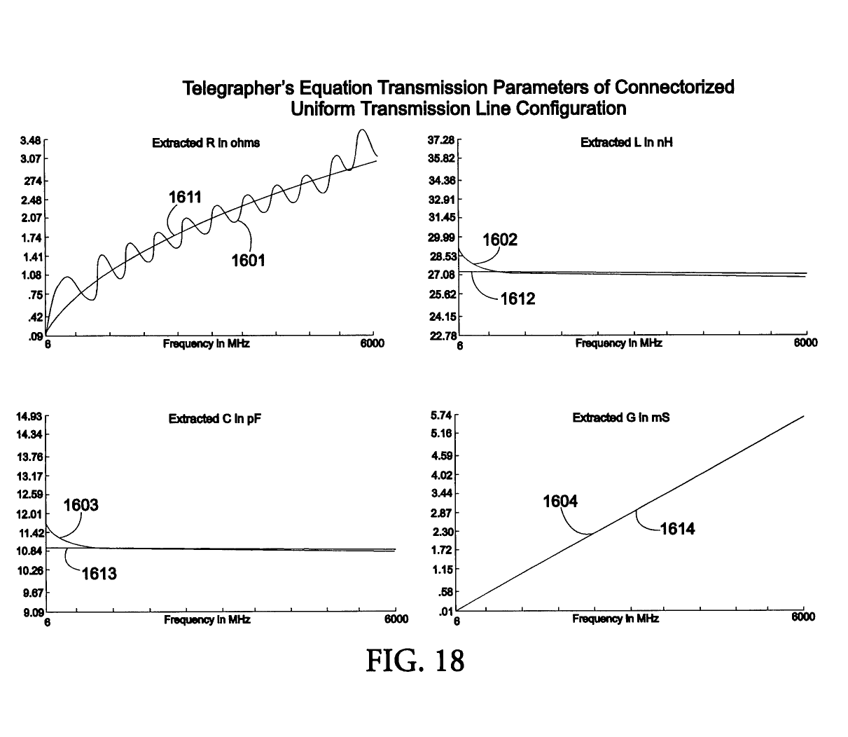

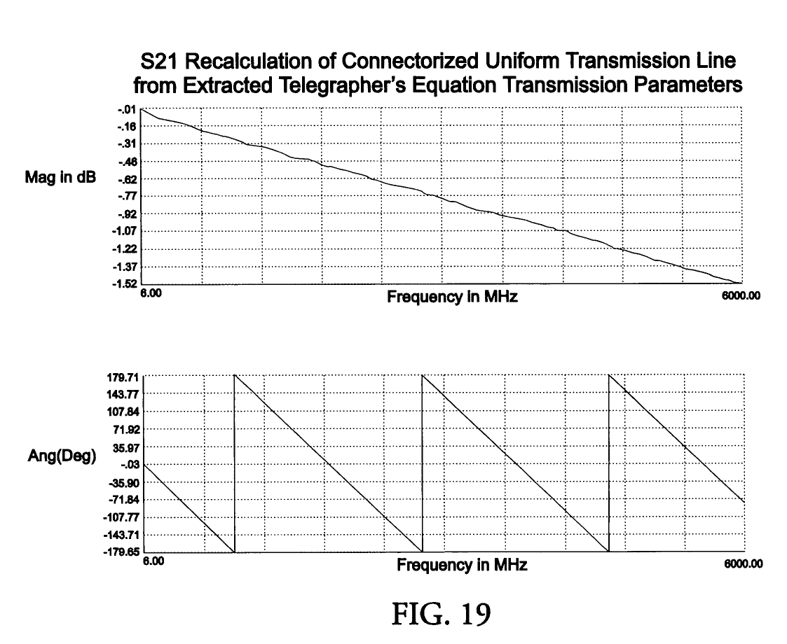

In another example of a method according to the present teachings, the connectorized configuration of the uniform transmission line 101a is characterized. With specific reference to FIGS. 2 and 3 of the drawings, the VNA measurement system 100 is calibrated using coaxial impedance references (not shown) by conventional methods to establish the measurement plane 205 at the VNA measurement ports 111. The connectorized uniform transmission line 101a is connected to the VNA measurement ports 111 and the VNA measurement system 100 measures the S-parameters. An impulse response transformation is made of the resulting S₁₁ parameter, and based upon the minimum and maximum values 701, 702 of the transformation, the start and stop gates 703, 704 are established as described herein. As one of ordinary skill in the art appreciates, the s-parameters and impulse response transformations of the connectorized uniform transmission line 101a are different from the probed uniform transmission line configuration 101b. The relative profile of the S₁₁ impulse response transformation for the connectorized uniform transmission line 101a, however, is similar to the probed configuration of the uniform transmission line 101b and includes two delineations that indicate the presence and relative position of the connectivity system. Following the method as described in FIG. 15 of the drawings and with specific reference to FIG. 16 of the drawings, the electrical length 706 between the start and stop gates 703, 704 represents the electrical length of a representative portion of the connectorized configuration of the uniform transmission line 101a and is selected to be equal to the electrical length chosen for the probed uniform transmission line configuration 101b shown in FIG. 8 of the drawings. FIG. 17 of the drawings is a graph of just the gated S₁₁ impulse response for the connectorized uniform transmission line configuration. The stop and start gates 703, 704 establish 1503 a gated S₁₁ impulse response transformation, which is, converted 1504 to the frequency domain using an FFT. The phase component of S₁₁ is adjusted 1505 so that the measurement reference plane 205 coincides with the start gate 703. The S₂₁ parameter is then transformed 1506 to the impulse response time domain equivalent where a peak value indicates a total electrical length of the connectivity system in combination with the transmission line 101a. The phase component of S₂₁ is then adjusted 1507 by the electrical length of the input and output portions of the connectivity system and the magnitude component is scaled 1508 so that the loss represented by the S₂₁ parameter represents only the loss attributable to the representative portion of the measured uniform transmission line 101a. From the adjusted S₁₁ and S₂₁ parameters, the Telegrapher's Equation transmission parameters, RLCG, are extracted 1509. With specific reference to FIG. 18 of the drawings, there is shown the extracted Telegrapher's Equation transmission parameters 1601, 1602, 1603, and 1604 overlaid with the parameters resulting from a least squares fit of the extracted values 1611, 1612, 1613, and 1614 for the connectorized uniform transmission line configuration 101a. As one of ordinary skill in the art can see from FIG. 18, the fitted parameters as a function of frequency show close correlation with expected curves for a uniform transmission line. With specific reference to FIG. 19 of the drawings, there is shown a graph of S₂₁ recalculated from the fitted Telegrapher's Equation transmission parameters for the connectorized uniform transmission line configuration 101a. As one of ordinary skill in the art can appreciate with a comparison against FIG. 14 of the drawings, the S₂₁ transmission parameter recalculated from extracted Telegrapher Equation transmission parameters based upon measurements made of the connectorized uniform transmission line configuration 101a show close correlation to the S₂₁ transmission parameters based upon measurements made of the probed uniform transmission line configuration 101b for the same gated electrical length. The comparison and apparent close correlation between the two graphs provides indication that the method according to the present teachings has successfully removed the effects of the connectivity system and has gated the same electrical length of uniform transmission line so that the resulting S₂₁ transmission parameters for each configuration based solely on the representative portion of the respective uniform transmission lines are substantially similar as is expected based upon their similar dimensions, materials and manufacturing process.

Illustrative examples according to the present teachings have been described. Alternatives consistent with the present teachings will occur to one of ordinary skill in the art. Specifically, probed and connectorized connectivity systems are shown. The present teachings are also applicable to other forms of connectivity systems.

1. A method of modeling a uniform transmission line comprising the steps of:
obtaining measured s-parameters of a connectivity system in combination with said uniform transmission line,
mathematically isolating a representative portion of said uniform transmission line from said connectivity system by identifying an electrical position of a representative portion of said uniform transmission line as distinct from said connectivity system,
adjusting said measured s-parameters to represent s-parameters of only said representative portion of said uniform transmission line, and
extracting Telegrapher's Equation transmission parameters from said adjusted measured s-parameters.

2. A method as recited in claim 1 wherein said connectivity system in combination with said uniform transmission line comprises a connectorized transmission line configuration.

3. A method as recited in claim 1 wherein said connectivity system in combination with said uniform transmission line comprises a probed transmission line configuration.

4. A method as recited in claim 1 wherein said step of obtaining further comprises obtaining measured reflection and transmission s-parameters.

5. A method as recited in claim 4 wherein said step of mathematically isolating further comprises the steps of converting said measured reflection s-parameter to a measured reflection impulse response, identifying first and second uniform transmission line delineations in said measured reflection impulse response, identifying start and stop gates from said first and second uniform transmission line delineations, establishing a gated reflection impulse response, and converting said gated reflection impulse response to the frequency domain to obtain an adjusted reflection s-parameter.

6. A method as recited in claim 5 wherein said step of adjusting further comprises the steps of:
adjusting a phase component of said adjusted reflection s-parameter by shifting a reference plane by an electrical length equal to said start gate,
converting said measured transmission s-parameter to a measured transmission impulse response,
identifying an electrical length of said connectivity system in combination with said uniform transmission line, and
adjusting a phase component of said measured transmission s-parameter by adding an electrical length equal to a difference between said electrical length of said connectivity system in combination with said uniform transmission line and an electrical length between said start and stop gates.

7. A method as recited in claim 6 and further comprising the step of scaling a magnitude component of said measured transmission s-parameter.

8. A method as recited in claim 7 wherein said step of scaling further comprises adjusting said magnitude component of said measured transmission s-parameter by a percentage of the electrical length of said representative portion relative to said electrical length of said connectivity system in combination with said uniform transmission line.

9. A method as recited in claim 1 wherein said Telegrapher's Equation transmission parameters comprise normalized resistance, inductance, capacitance, and admittance values per unit length.

10. A method as recited in claim 1 and further comprising the step of calculating a complex characteristic impedance and complex propagation constant from said Telegrapher's Equation transmission parameters.

11. An apparatus for modeling a uniform transmission line comprising:
a measurement system for obtaining measured s-parameters of a connectivity system in combination with said uniform transmission line, and
a processor together with program control means for mathematically isolating a representative portion of said uniform transmission line from said connectivity system by identifying an electrical position of representative portion of said uniform transmission line as distinct from said connectivity system, adjusting said measured s-parameters to represent s-parameters of only said representative portion of said uniform transmission line, and extracting Telegrapher's Equation transmission parameters from said adjusted measured s-parameters.

12. An apparatus as recited in claim 11 wherein said connectivity system in combination with said uniform transmission line comprises a connectorized transmission line.

13. An apparatus as recited in claim 11 wherein said connectivity system in combination with said uniform transmission line comprises a probed transmission line.

14. An apparatus as recited in claim 11 wherein said step of obtaining further comprises obtaining measured reflection and transmission s-parameters.

15. A method as recited in claim 14 wherein said program control means for mathematically isolating further comprises means for converting said measured reflection s-parameter to a measured reflection impulse response, means for identifying first and second uniform transmission line delineations in said measured reflection impulse response, means for identifying start and stop gates from said first and second uniform transmission line delineations, means for establishing a gated reflection impulse response, and means for converting said gated reflection impulse response to the frequency domain to obtain an adjusted reflection s-parameter.

16. An apparatus as recited in claim 15 wherein said means for adjusting further comprises
means for adjusting a phase component of said adjusted reflection s-parameter by shifting a reference plane by an electrical length equal to said start gate,
means for converting said measured transmission s-parameter to a measured transmission impulse response,
means for identifying an electrical length of said connectivity system in combination with said uniform transmission line, and
means for adjusting a phase component of said measured transmission s-parameter by adding an electrical length equal to a difference between said electrical length of said connectivity system in combination with said uniform transmission line and an electrical length between said start and stop gates.

17. An apparatus as recited in claim 16 and further comprising means for scaling a magnitude component of said measured transmission s-parameter.

18. An apparatus as recited in claim 17 wherein said means for scaling further comprises means for adjusting said magnitude component of said measured transmission s-parameter by a percentage of said electrical length of said representative portion relative to said electrical length of said connectivity system in combination with said uniform transmission line.

19. An apparatus as recited in claim 11 wherein said Telegrapher's Equation transmission parameters comprise normalized resistance, inductance, capacitance, and admittance values per unit length.

20. An apparatus as recited in claim 11 and further comprising the step of calculating a complex characteristic impedance and complex propagation constant from said Telegrapher's Equation transmission parameters.

21. A method of modeling a uniform transmission line comprising the steps of:
obtaining measured reflection and transmission s-parameters of a connectivity system in combination with said uniform transmission line,
converting frequency domain representations of said s-parameters to respective impulse response time domain representations,
identifying a start gate, a stop gate, and an electrical length of said connectivity system and uniform transmission line combination from said time domain representations,
establishing a gated reflection impulse response for only a representative portion of said uniform transmission line as distinct from said connectivity system based upon said start gate and said stop gate,
converting said gated reflection impulse response to a gated reflection s-parameter,
adjusting a phase component of said measured transmission s-parameters to represent s-parameters of only said representative portion of said uniform transmission line,
scaling said magnitude component of said transmission s-parameter as a percentage of electrical length of said representative portion relative to said electrical length of said connectivity system and uniform transmission line combination and
extracting Telegrapher's Equation transmission parameters from said adjusted measured s-parameters.

22. A method as recited in claim 21 wherein said step of adjusting a phase component further comprises the steps of shifting a reference plane of said phase component by an electrical length equal to said start gate.

23. A method as recited in claim 21 wherein said connectivity system in combination with said uniform transmission line comprises a connectorized transmission line.

24. A method as recited in claim 21 wherein said connectivity system in combination with said uniform transmission line comprises a probed transmission line.

25. A method as recited in claim 21 wherein said step of obtaining comprises taking measurements on a vector network analyzer.

26. A method as recited in claim 21 wherein said step of obtaining comprises retrieving measurement data from data storage media.
